(19) United States
(12) Patent Application Publication
(10) Pub. No.: US 2026/0228582 A1
(43) Pub. Date: Aug. 6, 2026

(54) QUANTUM CIRCUIT EXECUTION WITH SPARE QUBITS FOR STATE INTEGRITY USING PHASE SHIFT AND DELAY

(71) Applicant: Dell Products L.P., Round Rock, TX (US)

(72) Inventors: Tejinder Singh, Manotick (CA); Navjot Kaur Khaira, Manotick (CA); Brendan Healy, Haddonfield, NJ (US); Romulo Teixeira de Abreu Pinho, Niterói (BR)

(21) Appl. No.: 19/045,456

(22) Filed: Feb. 4, 2025

(51) Int. Cl. G06N 10/20

(52) U.S. Cl. CPC G06N 10/20

(57) ABSTRACT

The technology described herein is directed towards using active qubits for quantum circuit execution, in which operations on active qubits are replicated onto spare qubits for purposes of quantum state measurement data integrity verification. Spare qubits are available qubits in a quantum system that are not actively used for executing quantum operations. Via the information measured from the spare qubits, state measurement data integrity can be verified with fewer repeated multiple executions (shots) that use only active qubits. Variable, known amounts of phase shift, rotation and/or delay can be applied to a spare qubit. When measured, the spare qubit measurement data can be evaluated for whether the applied phase shift, rotation and/or delay remained the same following quantum operations; if so, the probability of the measured data being correct is increased. Active qubits can be measured in the Z-basis; spare qubits can be measured in the X-basis and Y-basis.

### BACKGROUND

Quantum computing machines can process n qubits to represent information in a superposition space of size 2ⁿ. In quantum computing, as a result of noise, quantum fluctuations and probabilistic behavior, extracting this quantum information is obtained via multiple executions and corresponding measurements, known as “shots,” which increase exponentially with the number of qubits.

### BRIEF DESCRIPTION OF THE DRAWINGS

The technology described herein is illustrated by way of example and not limited to the accompanying figures in which like reference numerals indicate similar elements and in which:

FIGS. 1 and 2 depict an example hybrid classical-quantum system for controlling and measuring qubit operations, including via selectively applied variable phase shifts to spare qubits, in accordance with various example embodiments and implementations of the subject disclosure.

FIG. 3 is an example quantum circuit for manipulating and measuring active and spare qubits using quantum gates, phase shifts, and rotations, in accordance with various example embodiments and implementations of the subject disclosure.

FIGS. 4 and 5 comprise a sequence diagram showing example operations of the quantum circuit of FIG. 3, in accordance with various example embodiments and implementations of the subject disclosure.

FIGS. 6 and 7 depict an alternative example hybrid classical-quantum system for controlling and measuring qubit operations, including via selectively applied variable phase shifts to spare qubits via a hardware based phase shifter, in accordance with various example embodiments and implementations of the subject disclosure.

FIG. 8 is a flow diagram showing example operations related to validating integrity of active qubit measurement data, based on measurement data of a spare qubit to which controlled phase shift and rotation are applied, in accordance with various example embodiments and implementations of the subject disclosure.

FIG. 9 is a flow diagram showing example operations related to verifying quantum state integrity based on measurement data of active qubits and spare qubits, in accordance with various example embodiments and implementations of the subject disclosure.

FIGS. 10 and 11 comprise a flow diagram showing example operations related to executing quantum operations on four qubits of a quantum circuit, in which phase shift and rotation are applied to two of the qubits, in accordance with various example embodiments and implementations of the subject disclosure.

### DETAILED DESCRIPTION

The technology described herein is generally directed to using “spare” qubits, for the extraction of additional information from a single shot (an execution of a quantum operation), thereby reducing the number of quantum algorithm executions that are typically repeated as shots to obtain measurement data considered as probabilistically valid. In general, an “active” qubit as referred to herein is a qubit used to execute a quantum operation; a spare qubit is one that is not actively used for the execution of the quantum operation by the active qubit. It is very common that only a small percentage of available qubits are used to execute a program, e.g., as few as two qubits may be used to execute a program, when dozens of qubits are otherwise available and thus are spare.

As described herein, the number of shots can be reduced, e.g., to as little as one shot, by replicating operations from active qubits onto spare qubits, followed by measurements along different axes. The use of one or more spare qubits allow for the extraction of additional information from a single shot, significantly reducing the total number of shots needed to ensure valid measurement data. Moreover, the technology facilitates the incorporation of variable phase shifts on spare qubits, allowing for dynamic error verification based on known parameters such as phase and delay. By correlating the known delay and the variable phase added through a phase shifter, it is reasonable to validate measurement accuracy by ensuring that only measurements that adhere to these known parameters are accepted.

Thus, the use of spare qubits, which are available but otherwise unused, results in more optimal resource utilization when compared to the current practice of performing numerous shots, which diminish at least some of the benefits obtained by quantum processing speeds. Further, the inclusion of a variable phase shifter adds an extra layer of fidelity, in which the correlation between the known delay and measured phase further ensures the integrity of the quantum states. Indeed, applying a variable phase shifter to measure additional parameters such as phase and delay enables relatively precise error verification.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

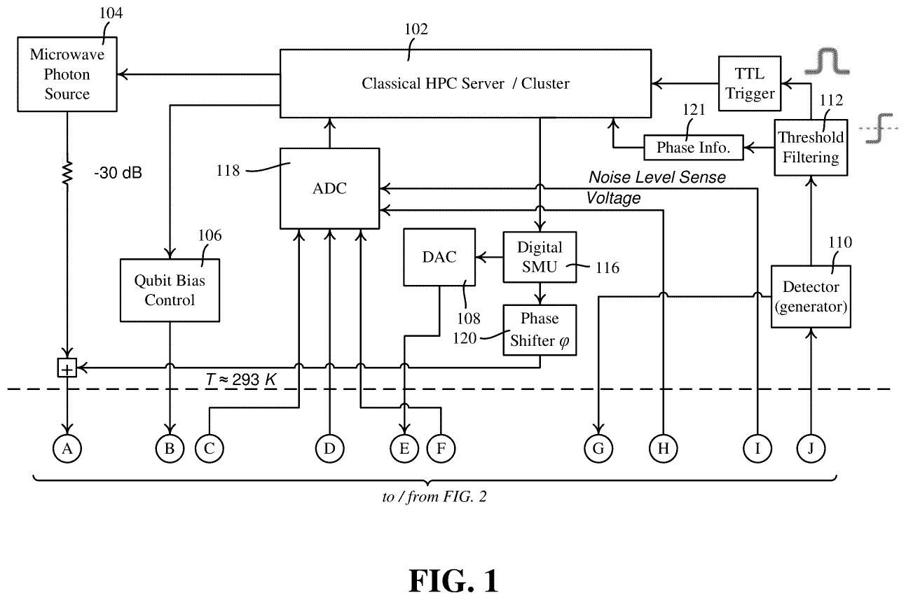

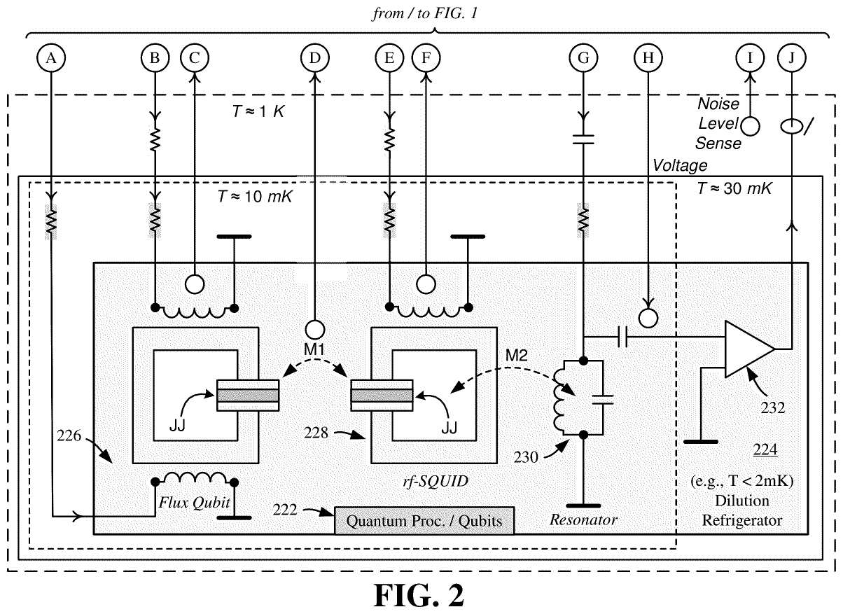

FIGS. 1 and 2 comprise a block diagram representation of an example quantum processor measurement and control setup/environment, in which qubit control and readout is facilitated by integrating a classical high-performance computing server/cluster 102 (FIG. 1) with a quantum computing system having a quantum processor and qubits 222 near the base plate of a dilution refrigerator 224, e.g., on the order of below 10 milli-Kelvin (mK).

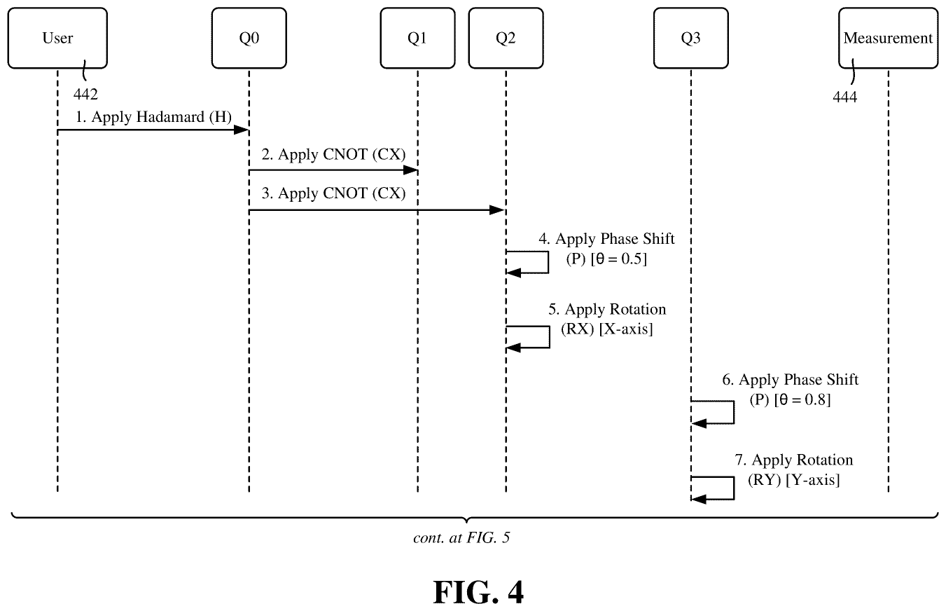

As shown in the example of FIGS. 1 and 2, a microwave photon source 104, FIG. 4, is controlled by the classical high-performance compute (HPC) server/cluster 102, both sitting at room temperature in this example. The microwave photons from the microwave photon source 104 go through multiple temperature stages to reach the flux qubits (e.g., 226) operating at a temperature below 2 mK in the dilution refrigerator 224 (FIG. 2; note that flux qubits can also be made using rf-SQUIDS). At each stage, along with the reducing temperature, the microwave signal is heavily attenuated as qubits are provided very low-power microwave photons. Note that the HPC server/cluster 102 can control operation of the photon source 104 in terms of pulses, e.g., the sequence of pulses, the width and voltage of the pulses and the like can be controlled by the classical server/cluster 102; any amount of gates can be applied to the qubit, to control the qubit and configure the qubit, including as described herein.

Qubit DC (direct current) bias control (block 106, FIG. 1) in the form of a constant voltage or current to adjust the energy levels of the qubit also can be provided from the classical HPC server/cluster 102. A change in the magnetic flux in the qubit 226 (FIG. 2, after absorption of a photon) induces a change in the mutual flux coupling (M1) with an rf-SQUID 228, which in general acts as a detector controlled by the server/cluster 102, e.g., via a digital-to-analog converter 108. The rf-SQUID 228 includes a superconducting loop across a Josephson Junction (JJ) characterized by its critical current (IC), capacitance (C), and shunt resistance (R).

To register signals in rf-SQUIDs, a readout resonator/LC (inductor-capacitor) tank circuit 230 is used, including an inductor (LT) and a capacitor (CT), which together oscillate at a natural frequency ω_{T}/2 π=½π\sqrt{(L_{T}C_{T})}. The resonator 230 is designed to be sensitive to small changes in magnetic flux, mutually coupled (M2) to the rf-SQUID 228, as appropriate for detecting photon interactions with the qubit. An external pumping current I_{rf} sin(ω_{P}t) is provided (via labeled circle “G”) from a detector/generator 110 (FIG. 1) at frequency Ω/2π, which is very close to the natural frequency of the LC tank circuit resonator 230 (ω_{P}−ω_{T})/ω_{T}<<1 and quality factor Q>>1. The current/voltage bias (block 106) to the rf-SQUID 226 is very accurate to not (inadvertently) operate the rf-SQUID 226 in non-hysteresis mode.

Note that FIG. 2 only shows components for two rf-SQUIDS/qubits, however any practical number may be present in a given quantum computing configuration. Further note that the resonator 230 can obtain a control signal, and because any voltage generates the magnetic flux, a qubit state change will occur, as the generated magnetic flux will break the entanglement, or it will collapse the qubit; the system can read that what was the recent data, such as how much frequency changed in the resonator 230.

The output from the LC tank/resonator 230 is very weak, and hence is amplified (signal amplifier 232) and provided to the detector 110, which further performs threshold filtering (block 112) to quantize the state of the qubit, and provides the transistor-transistor logic (TTL) trigger (block 114) to the classical server/cluster 102. To ensure accurate control, a PCIe card interface-based digital source measure unit (SMU) 116 can be used, such as a high-performance SMU that is commercially available. A high-performance PXI-based SMU (PCI eXtensions for Instrumentation) provides fast, precise dynamic measurements from DC to a 20 μs pulse, with outputs up to 210 V/315 mA, 10 femtoampere (fA) resolution, and the lowest source noise.

Similarly, a commercially available PXI-based digital-to-analog converter (DAC) 108 can be used, such as one that features sixteen simultaneous channels capable of supplying stimulus waveforms with output voltages ranging from 0V to +30V, and output currents from 0 mA to +20 mA. In one implementation, both the SMU 116 and DAC 108 are compatible with PCIe interfaces and can be housed in a PXI chassis, which saves rack space and reduces maintenance cost. Also shown in FIG. 1 is an analog-to-digital converter (ADC) 118 coupled to the classical server/cluster 102 and a number of sensors (the small circles at various tap points in FIG. 2, corresponding to the circled labels C, D, F, H and I).

To summarize, the qubit can be configured with gates, the readout measured, and the qubit collapsed. The readout signal can be amplified, with the amplified signal sent to the detector; after threshold filtering that removes noise, the signal goes to the trigger, and the data goes back to the classical computer. This operates as a look, where the classical computer sources the information, processes it, and detects/reads it back. The digital SMU 116 and the DAC 108 can be built into the PCIe based classical control. Precision control is achieved because of the feedback, including between these detectors. The system can adjust filtering, the trigger mechanism, and so on, without requiring extensive separate vendor RF measurement equipment per qubit. Note that the amount of precision, e.g., to read noise levels beyond −120 dBm versus minus −100 dBm, how precisely to measure the flux, as well as how much adaptive control and so on, can be configured in software.

As described herein, in one example implementation, the digital SMU 116 can control a phase shifter (φ) 120 that can apply a phase shift to a qubit. In the example of FIG. 1, the phase shifter 120 can be a software phase delay added at the classical computer level, e.g., applied to the microwave photon before the photon enters the dilution refrigerator levels. Such software-based controlled phase shifts are used with respect to one or more spare qubits as described herein. Phase information (block 121) can be provided to the classical server/cluster 102. Such phase information allows real-time phase tuning and repeated measurements to ensure accurate quantum state tracking and error correction, e.g., if small phase deviations are detected between the applied phase and the measured phase following execution of one or more operations on the qubit as described herein, the phase can be adjusted and the operations reattempted and remeasured.

Thus, as generally represented in FIG. 1, hardware for control and readout can, for example, include one or more advanced source measure units (SMUs) and analog-to-digital converters (ADCs), which can be managed more efficiently with classical systems, thereby reducing the number of physical components and vendor equipment otherwise needed. Such a hybrid system can be designed modularly, where each module, including multiple qubits and their respective control/readout lines, can be independently managed by one or more classical processors. Such modularity simplifies system scaling, allowing new modules to be added without redesigning the entire control infrastructure.

The technology described herein leverages the precise classical control of the qubit control and measurement operations. For example, a classical high-performance computing server (or cluster of such servers) with peripheral component interconnect express (PCIe-based) or the like control can use a source measure unit (SMU) for quantum computers with some practical number (e.g., one the order of dozens) of qubits, including to apply controlled phase shift and controlled rotation to a qubit.

Further, the technology described herein controls the qubit readout circuit using a source measure unit and digital-to-analog converter; this can provide ultra-precise control of readouts with 10-15 Amperes of ultra-low signals. The hybrid classical-quantum technology described herein is, in part, directed to recording a photon-induced transition in a flux qubit, for example. Note however that photons/flux qubits are only examples, as indeed, the technology described herein is agnostic to any particular type of qubit, and further, that probe signals other than those based on microwave photons can be used, as appropriate for a given type of qubit.

The technology described herein leverages spare qubits in a quantum system to enhance the efficiency and accuracy of quantum algorithm execution. Unlike having a quantum system with underutilized qubits, operations from active qubits are duplicated to spare ones, thereby using such auxiliary qubits to improve measurement accuracy. Additionally, the introduction of a variable phase shift, combined with a known delay, ensures state integrity throughout the process, enabling error detection and correction. The technology provides a robust method for verifying the integrity of quantum states, as is appropriate for reliable quantum computation.

A first part of the duplicating of operations onto spare qubits is to identify spare qubits that are not actively used in the execution of the program (sometimes referred to as the algorithm). Once identified, the spare qubits are paired with active qubits, allowing the operations applied to the active qubits to be duplicated onto their auxiliary counterparts. More particularly, in one implementation, one-qubit gates such as the Hadamard or Pauli gates are replicated, while controlled two-qubit gates are only duplicated when the active qubit serves as the target qubit. This duplication ensures that the spare qubit mirrors the quantum state of the original qubit, allowing additional information to be extracted from the system. This both improves resource utilization and sets a foundation for more accurate and efficient measurements.

To maintain the integrity of the quantum states during execution, described herein is the application of a variable phase shift to the spare qubit using a phase shifter for verification of state integrity. The applied phase shift is combined with a known delay, allowing the system to verify whether the qubits have maintained their coherence and integrity. By tracking the phase shift and delay throughout the quantum operations, the system can determine whether any additional noise or the like has been introduced. If the phase information, combined with the known delay, remains consistent at the end of the measurement, the results indicate that the qubits have maintained their integrity without introducing noise.

Conversely, if the phase information deviates slightly from the expected values, this can be correlated to minor noise in the system. In this case, the system can adjust the phase and perform another round of measurements to ensure the quantum state integrity is still preserved. Further, if the phase information becomes random and significantly deviates from expectations, the phase information suggests substantial noise or disruption in the quantum state, whereby the measurements do not provide valid data, and one or more repetitions of the measurements are performed. The phase shift technique described herein is particularly effective for detecting such noise and ensuring that quantum states remain intact throughout the computation process.

It should be noted that the technology described herein avoids the phase flip limitation; that is, in many quantum systems, phase flips (where the phase is toggled between 0 and 180 degrees) are used to manage quantum states. However, this phase flip approach is inherently limited, as it only allows for two distinct states, which fails to provide sufficient granularity to verify the integrity of the quantum state. Such a simple 0 to 180-degree phase flip only offers two possible outcomes, which may not accurately reflect the presence of noise or state degradation. Instead, using a continuous variable phase shift as described herein allows for finer control and more detailed information about the state's behavior, making it easier to detect small changes in phase due to noise or interference.

By incorporating a variable phase shift, the system can capture more nuanced data about how the quantum state evolves over time and through interactions. This level of precision is significantly valuable in validating the integrity of quantum states, as the variable phase shift allows for more accurate error detection and correction. Indeed, the use of continuous phase shifts for enhanced measurement accuracy to make informed decisions about state integrity overcomes the phase flip limitation, which provides insufficient information compared to the information obtained via variable phase shifts.

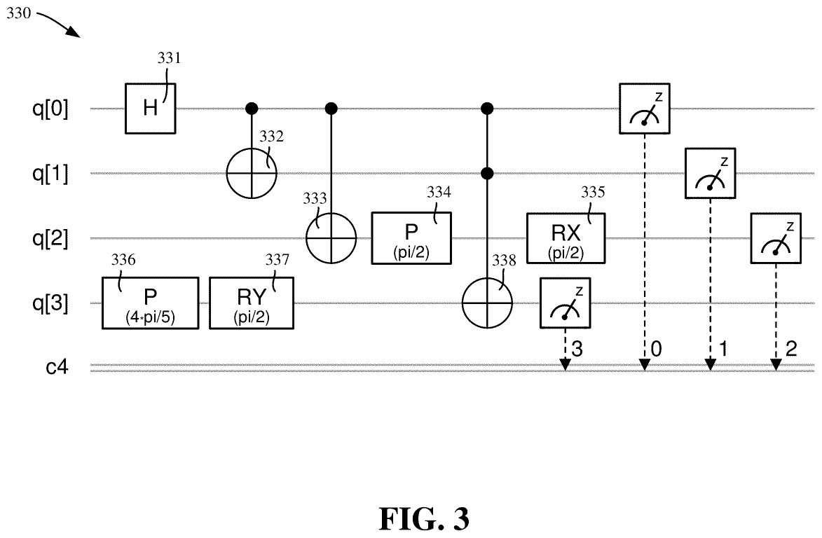

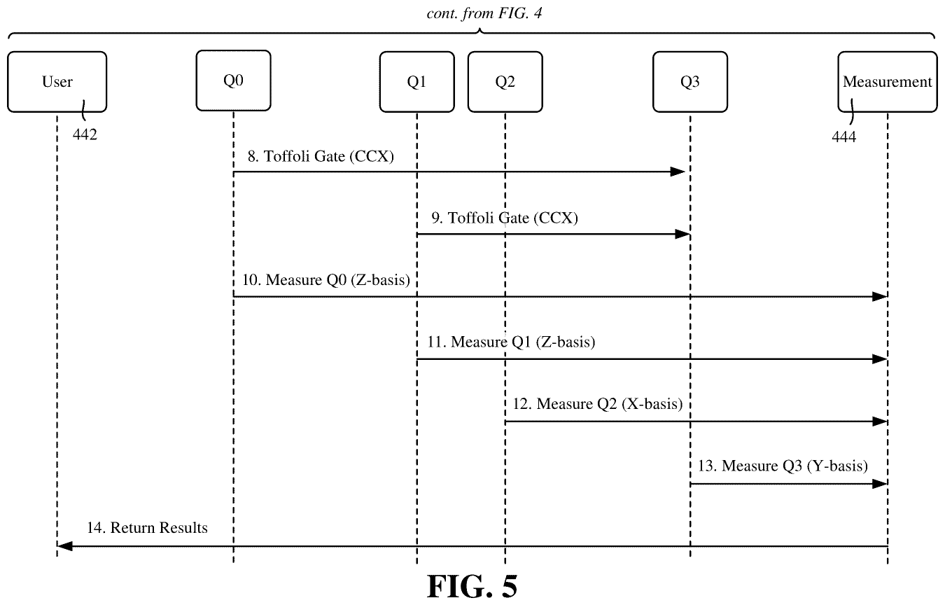

Turning to one example implementation, FIG. 3 shows a quantum circuit 330 that demonstrates the manipulating and measuring of qubits using quantum gates, phase shifts and rotations, leveraging phase and delay in quantum operations. The circuit shown in FIG. 3 begins by applying a Hadamard (H) gate 331 to the first qubit (Q0), placing it into superposition, in which Q0 can be in a mix of both the |0> and |1> states. This prepares Q0 for further entanglement. Applying the Hadamard gate 331 is also shown via arrow (1) in the sequence diagram of FIGS. 4 and 5, where the “user” 442 refers to controlling the system and sourced photons to place the first qubit (Q0) into superposition.

Following this, CNOT (Controlled NOT) gates 332 and 333 are used to entangle Q0 with both Q1 and Q2. Entanglement is a feature of quantum systems, ensuring that the states of qubits (Q0, Q1 and Q2 in this example) are correlated and that changes to one will affect the others. These operations set up the quantum system for further phase manipulation. Applying the CNOT gates 332 and 333 is also shown via arrows (2) and (3), respectively, in the sequence diagram of FIGS. 4 and 5.

Next, phase shifts and rotations are applied to Q2 and Q3, simulating how the quantum states evolve over time, or under the influence of different physical processes like delays or noise. In one example implementation represented by block 334 in FIG. 3, and by arrow (4) in FIG. 4, a phase shift of 0.5π is applied to Q2, introducing a controlled change in its phase. This modifies how Q2's state is measured later on. Further, as represented by block 335 in FIG. 3, and by arrow (5) in FIG. 4, Q2 is rotated along the X-axis by π/2 radians. This rotation changes the qubit's orientation in the Bloch sphere, preparing it for measurement in a different basis.

In this example implementation, for Q3 a larger phase shift of 0.8π is applied, representing a different phase delay, as represented by block 336 in FIG. 3, and by arrow (6) in FIG. 4. This phase shift (block 336) is followed by a Y-axis rotation of π/2 (block 337 in FIG. 3 and arrow (7) in FIG. 4), altering Q3's quantum state in a different dimension compared to Q2. These rotations and phase shifts allow the system to probe the qubits' states from different perspectives and analyze how they evolve.

As represented in FIG. 3, a Toffoli gate (controlled-controlled-NOT, or CCX gate) 338 is applied, where Q0 and Q1 act as control qubits, and Q3 is the target qubit. This gate is a three-qubit operation that only flips Q3 if both Q0 and Q1 are in the |1> state. The Toffoli gate 338 introduces non-linear behavior into the system and highlights multiqubit control in quantum circuits. The operation is also represented in the sequence diagram (continued in FIG. 5) by arrow (8).

A next part of the circuit involves measuring the qubits in different bases to extract information about their states. Q0 and Q1 are measured (block 444 in FIGS. 4 and 5) in the Z-basis (the standard computational basis), which provides information about their final states after the entanglement and other operations. Q2, a first spare qubit (of the spare qubit subgroup that includes Q2 and Q3) is measured in the X-basis to detect the impact of the phase shift and rotation applied earlier. This helps assess how Q2's state was affected by the transformations. Q3, the second spare qubit, is measured in the Y-basis, to observe the combined effects of the phase shift and delay on its state.

Although the example of FIG. 3-5 showed certain gates, the technology described herein is not limited to any type of gate. Indeed, the use of one or more spare qubits can verify the integrity of measurement data following any quantum operations using any gates. The spare qubits, to which delay and/or phase shift are applied, when measured can be used to determine whether the known, controlled delay that was added propagated correctly or did not do so. Similarly, whether the intentionally added amount of variable phase shift propagated can be used to evaluate the measurement. If so, the probability is reasonably high that the measurement was correct, e.g., observed in the zero state or the one state.

Note further that multiple spare qubits, which are often available, can be used to measure for validation. For example, in addition to the two spare qubits Q2 and Q3 in FIG. 3 5, there could be more spare qubits included in the quantum circuit, (such as one or more of Q4, Q5, Q6 and so on), each having a different known amount of delay and/or phase shift applied, to increase the probability of the measurement data being correct when even more spare qubit measurement results are returned with the measured delays and/or phase shifts matching what was applied.

To summarize, the Hadamard gate 331 on the first qubit Q0 creates superposition, allowing Q0 to be in both |0> and |1> states simultaneously. The CNOT gate 332 between Q0 and the second qubit Q1, and the CNOT gate 333 between Q0 and the third qubit Q2, entangle these qubits, meaning their states are correlated. This entanglement mimics the idea of a main quantum circuit where quantum operations are performed.

Phase shift and rotation (blocks 334 and 335) on the qubit Q2 (a spare qubit-like function are performed such that Q2 undergoes a phase shift (0.5π) and an X-axis rotation (π/2). This mirrors the concept of a spare qubit that is manipulated using phase shift and delay (rotation) to verify if the state remains coherent. Measuring Q2 in the X-basis allows the system to check how the phase shift impacted the state and helps validate the integrity of the qubit state post-operation. This is similar to how the spare qubit's phase is manipulated to simulate delay and check for noise.

With respect to phase shift and rotation (blocks 337 and 337) on Q3, Q3 receives a different phase shift (0.8π) and a Y-axis rotation (π/2), simulating the effect of a longer delay or a different phase on the qubit. Measuring Q3 in the Y-basis captures the phase and delay effects. The use of different axes for measurement (X for Q2 and Y for Q3) provides the ability to check multiple aspects of the qubit states after they have undergone different transformations, including phase shifts and rotations.

The Toffoli gate (CCX) applied to Q0, Q1, and the target Q3 introduces a more complex operation. The gate's result is controlled by Q0 and Q1 and operates on Q3, adding complexity to the system, as in a quantum program. For state integrity measurement, Q0 and Q1 are measured in the Z-basis, capturing their final states in the computational basis. Q2 and Q3 are measured in the X-basis and Y-basis, respectively, allowing the system to verify how the phase shifts and rotations affected the states of these qubits.

As can be seen thus far, the technology described herein overcomes many issues with existing solutions to verifying qubit measurements. Typical quantum programs use multiple measurements or “shots” due to noise, decoherence, and the stochastic nature of quantum states; the number of shots often grows exponentially with the number of qubits, reducing the potential advantage of quantum computing. Instead of suboptimal resource utilization when executing many quantum algorithms, in which there are often many qubits that are left idle and wasted, (especially on larger machines with higher qubit counts), the overall computational process is improved by the technology described herein of utilizing such spare qubits, which are valuable resources.

Still further, the technology described herein provides additional useful information, unlike the limited information obtained through standard measurements; standard measurements in quantum systems typically occur along one axis (such as the Z-axis on the Bloch sphere), which limits the amount of information that can be obtained about the quantum state. In certain cases, such as for states along the equatorial plane of the Bloch sphere, measurements along the Z-axis may not provide sufficient information, whereas the measurements of spare qubits are along the X-axis and Y-axis. Ensuring state integrity and error detection is significant, particularly for high precision programs, because quantum states are fragile and susceptible to noise, errors, and decoherence. Conventional quantum error correction techniques can be resource-intensive, including multiple shots as described herein. Further there are quantum state separability challenges with conventional measurements, as quantum algorithms often deal with entangled or correlated states, which can make it challenging to separate or extract information from individual qubits. In such cases, using additional measurements may not always lead to useful results due to the complexity of the entangled states.

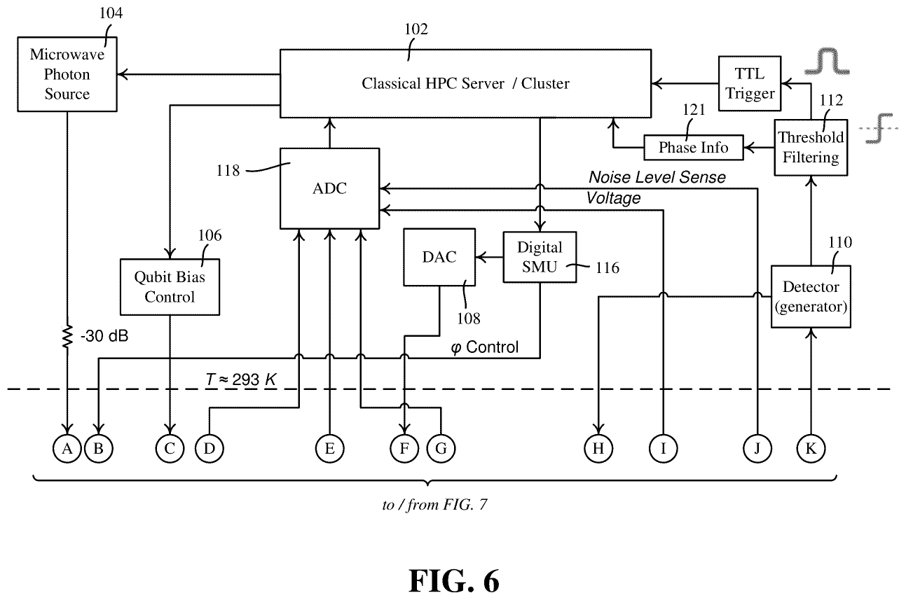

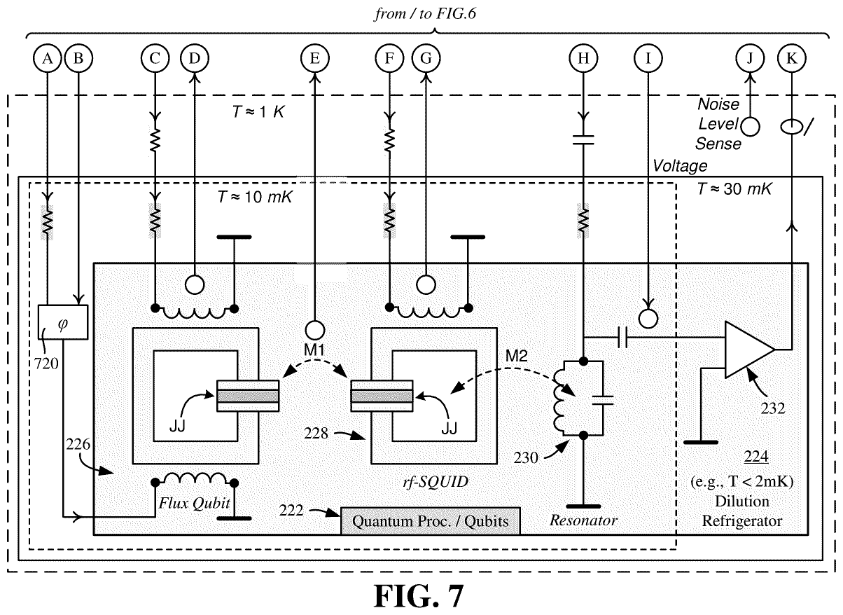

While for practical (e.g., cost and space) reasons software-based phase shifters are described herein with reference to the example implementation of FIGS. 1 and 2, the technology described herein is not limited to software-based phase shifters, but can alternatively implement hardware phase shifters. FIGS. 6 and 7 are similar to FIGS. 1 and 2, respectively, and most of the components are not described again for purposes of brevity. However, in FIGS. 6 and 7, a hardware phase shifter 720 is used, located in the 10 mK temperature region in this example. Control of the variable phase shift via the hardware phase shifter 720 in this example implementation is via the digital SMU 116.

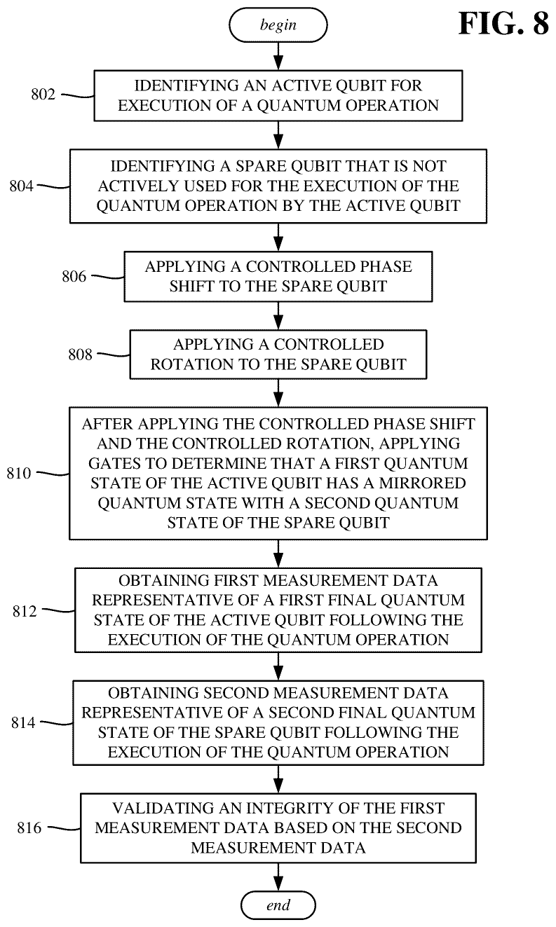

One or more concepts described herein can be embodied in a system, such as represented in the example operations of FIG. 8, and for example can include at least one memory that stores computer executable components and/or operations, and at least one processor that executes computer executable components and/or operations stored in the memory. Example operations can include operation 802, which represents identifying an active qubit for execution of a quantum operation. Example operation 804 represents identifying a spare qubit that is not actively used for the execution of the quantum operation by the active qubit. Example operation 806 represents applying a controlled phase shift to the spare qubit. Example operation 808 represents applying a controlled rotation to the spare qubit. Example operation 810 represents, after applying the controlled phase shift and the controlled rotation, applying gates to determine that a first quantum state of the active qubit has a mirrored quantum state with a second quantum state of the spare qubit. Example operation 812 represents obtaining first measurement data representative of a first final quantum state of the active qubit following the execution of the quantum operation. Example operation 814 represents obtaining second measurement data representative of a second final quantum state of the spare qubit following the execution of the quantum operation. Example operation 816 represents validating an integrity of the first measurement data based on the second measurement data.

Validating the integrity of the first measurement data based on the second measurement data can include evaluating whether the second measurement data corresponds to the controlled phase shift and the controlled rotation applied to the spare qubit.

The first measurement data can correspond to a first measurement in a first axis, and wherein the second measurement data can correspond to a second measurement in a second axis corresponding to the controlled rotation applied to the spare qubit.

The active qubit can include a first active qubit, the spare qubit can include a first spare qubit, and the system further can include a second active qubit entangled with the first active qubit, and a second spare qubit entangled with the first active qubit and the second active qubit.

The controlled phase shift can be a first controlled phase shift, the controlled rotation can be a first controlled rotation, and further operations can include applying a second controlled phase shift to the second spare qubit, and applying a second controlled rotation to the second spare qubit.

Further operations can include obtaining third measurement data representative of a third final quantum state of the second active qubit following the execution of the quantum operation, obtaining fourth measurement data representative of a fourth final quantum state of the second spare qubit following the execution of the quantum operation; validating the integrity of the first measurement data can be further based on at least one of: the third measurement data, or the fourth measurement data.

Further operations can include applying a first quantum gate to the first active qubit to place the first active qubit into superposition, applying a second quantum gate to the first active qubit to entangle the second active qubit with the first active qubit, and applying a third quantum gate to the first active qubit to entangle the first spare qubit with the first active qubit.

The first quantum gate can include a Hadamard gate, the second quantum gate can include a first Controlled NOT (CNOT) gate, and the third quantum gate can include a second CNOT gate.

Further operations can include determining a fourth quantum state of the second spare qubit based on a Toffoli gate comprising the first active qubit as a first control qubit, the second active qubit as a second control qubit, and the second spare qubit as a target qubit.

The system further can include a classical computer; the controlled phase shift can include a software-based variable phase shift controlled via the classical computer.

The system further can include a hardware phase shifter device that can be controllable to vary the controlled phase shift.

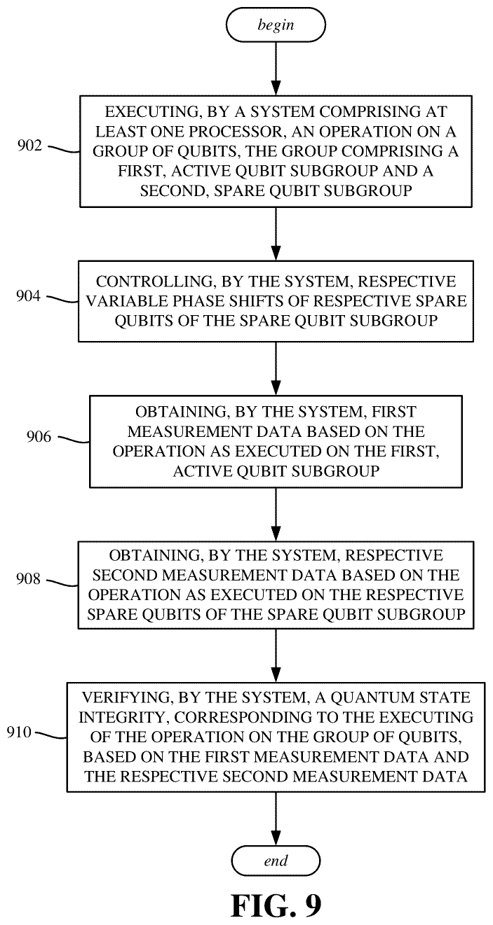

One or more example implementations and embodiments, such as corresponding to example operations of a method, can be represented in FIG. 9. Example operation 902 represents executing, by a system comprising at least one processor, an operation on a group of qubits, the group comprising a first, active qubit subgroup and a second, spare qubit subgroup. Example operation 904 represents controlling, by the system, respective variable phase shifts of respective spare qubits of the spare qubit subgroup. Example operation 906 represents obtaining, by the system, first measurement data based on the operation as executed on the first, active qubit subgroup. Example operation 908 represents obtaining, by the system, respective second measurement data based on the operation as executed on the respective spare qubits of the spare qubit subgroup. Example operation 910 represents verifying, by the system, a quantum state integrity, corresponding to the executing of the operation on the group of qubits, based on the first measurement data and the respective second measurement data.

Further operations can include controlling, by the system, respective variable rotations of the respective spare qubits of the spare qubit subgroup.

Verifying the quantum state integrity can include evaluating the respective second measurement data based on the respective phase shifts and respective rotations.

The respective spare qubits of the spare qubit subgroup can include a first spare qubit and a second spare qubit; controlling the respective variable phase shifts can include applying a first phase shift to the first spare qubit, and applying a second phase shift to the second spare qubit, in which the first phase shift can be different from the second phase shift, and controlling the respective variable rotations of can include applying an X-axis rotation to the first spare qubit, and applying a Y-axis rotation to the second spare qubit.

Obtaining the first measurement data can include measuring the active qubit subgroup in a Z-basis measurement, and obtaining the second measurement data can include measuring the first spare qubit in an X-basis measurement, and measuring the second spare qubit in a Y-basis measurement.

Further operations can include sourcing, by the system, a photon to a first active qubit of the active qubit subgroup; executing the operation can include applying a first gate to the first active qubit to place the first active qubit into superposition, applying a second quantum gate coupled to the first active qubit to determine a second quantum state of a second active qubit of the active qubit subgroup, applying a third quantum gate coupled to the first qubit to determine a third quantum state of a first spare qubit of the spare qubit subgroup, and applying a fourth quantum gate, coupled to the first qubit and the second qubit, to determine a fourth quantum state of a second spare qubit based on the first quantum state of the first qubit and the second quantum state of the second qubit.

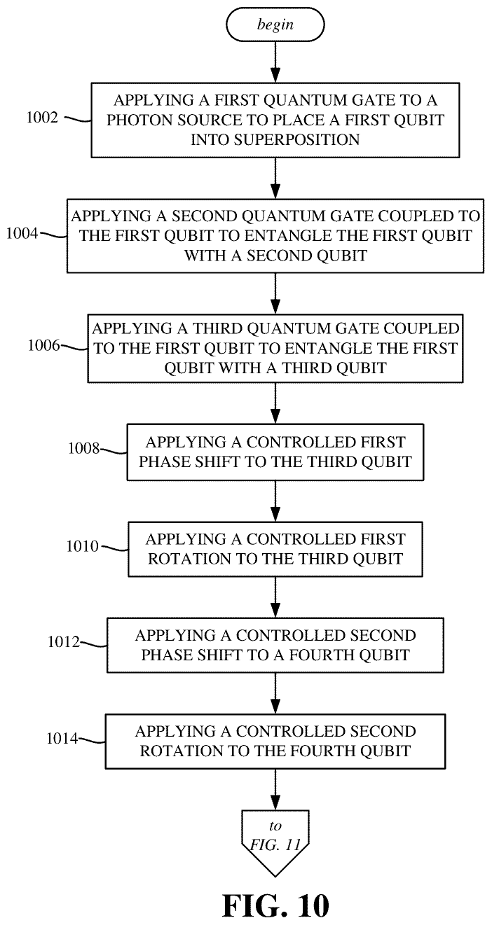

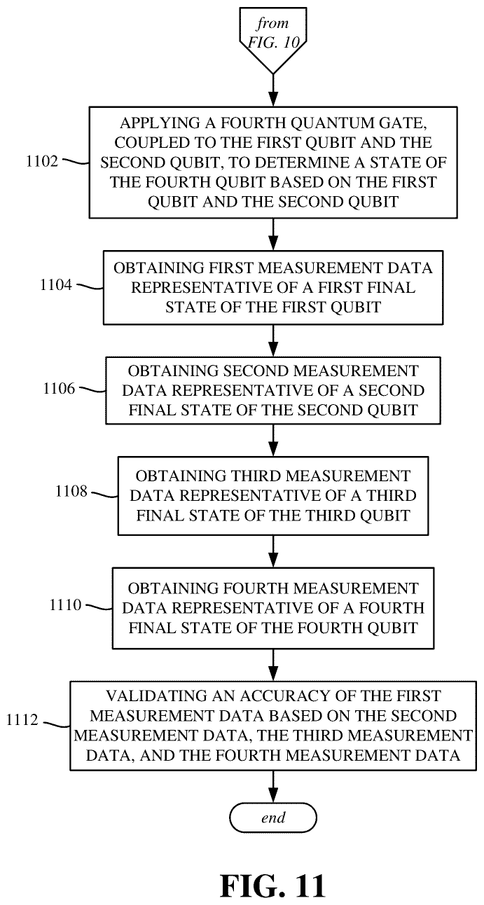

FIGS. 10 and 11 summarize various example operations, e.g., corresponding to a machine-readable medium, comprising executable instructions that, when executed by at least one processor of network equipment, facilitate performance of operations. Example operation 1002 of FIG. 10 represents applying a first quantum gate to a photon source to place a first qubit into superposition. Example operation 1004 represents applying a second quantum gate coupled to the first qubit to entangle the first qubit with a second qubit. Example operation 1006 represents applying a third quantum gate coupled to the first qubit to entangle the first qubit with a third qubit. Example operation 1008 represents applying a controlled first phase shift to the third qubit. Example operation 1010 represents applying a controlled first rotation to the third qubit. Example operation 1012 represents applying a controlled second phase shift to a fourth qubit. Example operation 1014 represents applying a controlled second rotation to the fourth qubit. The operations continue at example operation 1102 of FIG. 11, which represents applying a fourth quantum gate, coupled to the first qubit and the second qubit, to determine a state of the fourth qubit based on the first qubit and the second qubit. Example operation 1104 obtaining first measurement data representative of a first final state of the first qubit. Example operation 1106 obtaining second measurement data representative of a second final state of the second qubit. Example operation 1108 obtaining third measurement data representative of a third final state of the third qubit. Example operation 1110 obtaining fourth measurement data representative of a fourth final state of the fourth qubit. Example operation 1112 validating an accuracy of the first measurement data based on the second measurement data, the third measurement data, and the fourth measurement data.

Validating the accuracy of the third measurement data can be based on the controlled the first phase shift and a measured first phase shift, and validating the accuracy of the fourth measurement data can be based on the controlled second phase shift and a measured second phase shift.

Obtaining of the first measurement data can include obtaining the first measurement data in a first Z-basis measurement, and obtaining the second measurement data in a second Z-basis measurement; applying the controlled first rotation to the third qubit can include applying an X-axis rotation to the third qubit, applying the controlled second rotation to the fourth qubit can include applying a Y-axis rotation to the third qubit; obtaining the third measurement data can include obtaining the third measurement data in an X-basis measurement, and obtaining the fourth measurement data can include obtaining the fourth measurement data in a Y-basis measurement.

As can be seen, the technology described herein leverages spare qubits already available in the system, duplicating operations onto the spare qubits. One implementation applies variable phase shifts, combined with known delays, to track and verify quantum state integrity during execution and applying variable phase shifts and delay tracking, facilitating more efficient verification of state integrity with fewer resources. By measuring the spare qubit along different axes and correlating phase shifts with known delays, the technology described ensures the quantum state remains intact, while detecting and correcting noise dynamically. This is an efficient and scalable solution, reducing the number of required shots and avoiding the high overhead of traditional error correction and measurement techniques.

Slight phase deviations can be correlated with noise levels, allowing dynamic error detection and prevention during quantum operations, e.g., by including a variable phase shifter between the microwave source and the qubits to allow real-time phase tuning and repeated measurements to ensure accurate quantum state tracking and error correction. At the same time, the technology described herein moves away from binary 0 to 180-degree phase flips, offering continuous phase adjustments for more precise state verification. The spare qubits can be measured along different axes (x or y) to extract additional information without increasing the number of shots.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
at least one processor; and
at least one memory that stores executable instructions that, when executed by the at least one processor, facilitate performance of operations, the operations comprising:
identifying an active qubit for execution of a quantum operation;
identifying a spare qubit that is not actively used for the execution of the quantum operation by the active qubit;
applying a controlled phase shift to the spare qubit;
applying a controlled rotation to the spare qubit;
after applying the controlled phase shift and the controlled rotation, applying gates to determine that a first quantum state of the active qubit has a mirrored quantum state with a second quantum state of the spare qubit;
obtaining first measurement data representative of a first final quantum state of the active qubit following the execution of the quantum operation;
obtaining second measurement data representative of a second final quantum state of the spare qubit following the execution of the quantum operation; and
validating an integrity of the first measurement data based on the second measurement data.

2. The system of claim 1, wherein the validating of the integrity of the first measurement data based on the second measurement data comprises evaluating whether the second measurement data corresponds to the controlled phase shift and the controlled rotation applied to the spare qubit.

3. The system of claim 1, wherein the first measurement data corresponds to a first measurement in a first axis, and wherein the second measurement data corresponds to a second measurement in a second axis corresponding to the controlled rotation applied to the spare qubit.

4. The system of claim 1, wherein the active qubit comprises a first active qubit, wherein the spare qubit comprises a first spare qubit, and further comprising a second active qubit entangled with the first active qubit, and a second spare qubit entangled with the first active qubit and the second active qubit.

5. The system of claim 4, wherein the controlled phase shift is a first controlled phase shift, wherein the controlled rotation is a first controlled rotation, and wherein the operations further comprise applying a second controlled phase shift to the second spare qubit, and applying a second controlled rotation to the second spare qubit.

6. The system of claim 5, wherein the operations further comprise obtaining third measurement data representative of a third final quantum state of the second active qubit following the execution of the quantum operation, obtaining fourth measurement data representative of a fourth final quantum state of the second spare qubit following the execution of the quantum operation, and wherein the validating of the integrity of the first measurement data is further based on at least one of: the third measurement data, or the fourth measurement data.

7. The system of claim 6, wherein the operations further comprise applying a first quantum gate to the first active qubit to place the first active qubit into superposition, applying a second quantum gate to the first active qubit to entangle the second active qubit with the first active qubit, and applying a third quantum gate to the first active qubit to entangle the first spare qubit with the first active qubit.

8. The system of claim 7, wherein the first quantum gate comprises a Hadamard gate, wherein the second quantum gate comprises a first Controlled NOT (CNOT) gate, and wherein the third quantum gate comprises a second CNOT gate.

9. The system of claim 7, wherein the operations further comprise determining a fourth quantum state of the second spare qubit based on a Toffoli gate comprising the first active qubit as a first control qubit, the second active qubit as a second control qubit, and the second spare qubit as a target qubit.

10. The system of claim 1, further comprising a classical computer, wherein the controlled phase shift comprises a software-based variable phase shift controlled via the classical computer.

11. The system of claim 1, further comprising a hardware phase shifter device that is controllable to vary the controlled phase shift.

12. A method, comprising:
executing, by a system comprising at least one processor, an operation on a group of qubits, the group comprising a first, active qubit subgroup and a second, spare qubit subgroup;
controlling, by the system, respective variable phase shifts of respective spare qubits of the spare qubit subgroup;
obtaining, by the system, first measurement data based on the operation as executed on the first, active qubit subgroup;
obtaining, by the system, respective second measurement data based on the operation as executed on the respective spare qubits of the spare qubit subgroup; and
verifying, by the system, a quantum state integrity, corresponding to the executing of the operation on the group of qubits, based on the first measurement data and the respective second measurement data.

13. The method of claim 12, further comprising controlling, by the system, respective variable rotations of the respective spare qubits of the spare qubit subgroup.

14. The method of claim 13, wherein the verifying of the quantum state integrity comprises evaluating the respective second measurement data based on the respective phase shifts and respective rotations.

15. The method of claim 13, wherein the respective spare qubits of the spare qubit subgroup comprise a first spare qubit and a second spare qubit, wherein the controlling of the respective variable phase shifts comprises applying a first phase shift to the first spare qubit, and applying a second phase shift to the second spare qubit, wherein the first phase shift is different from the second phase shift, and wherein the controlling of the respective variable rotations of comprises applying an X-axis rotation to the first spare qubit, and applying a Y-axis rotation to the second spare qubit.

16. The method of claim 15, wherein the obtaining of the first measurement data comprises measuring the active qubit subgroup in a Z-basis measurement, and wherein the obtaining of the second measurement data comprises measuring the first spare qubit in an X-basis measurement, and measuring the second spare qubit in a Y-basis measurement.

17. The method of claim 12, further comprising sourcing, by the system, a photon to a first active qubit of the active qubit subgroup, and wherein the executing of the operation comprises:
applying a first gate to the first active qubit to place the first active qubit into superposition,
applying a second quantum gate coupled to the first active qubit to determine a second quantum state of a second active qubit of the active qubit subgroup,
applying a third quantum gate coupled to the first qubit to determine a third quantum state of a first spare qubit of the spare qubit subgroup, and
applying a fourth quantum gate, coupled to the first qubit and the second qubit, to determine a fourth quantum state of a second spare qubit based on the first quantum state of the first qubit and the second quantum state of the second qubit.

18. A non-transitory machine-readable medium, comprising executable instructions that, when executed by at least one processor, facilitate performance of operations, the operations comprising:
applying a first quantum gate to a photon source to place a first qubit into superposition;
applying a second quantum gate coupled to the first qubit to entangle the first qubit with a second qubit;
applying a third quantum gate coupled to the first qubit to entangle the first qubit with a third qubit;
applying a controlled first phase shift to the third qubit;
applying a controlled first rotation to the third qubit;
applying a controlled second phase shift to a fourth qubit;
applying a controlled second rotation to the fourth qubit;
applying a fourth quantum gate, coupled to the first qubit and the second qubit, to determine a state of the fourth qubit based on the first qubit and the second qubit;
obtaining first measurement data representative of a first final state of the first qubit;
obtaining second measurement data representative of a second final state of the second qubit;
obtaining third measurement data representative of a third final state of the third qubit;
obtaining fourth measurement data representative of a fourth final state of the fourth qubit; and
validating an accuracy of the first measurement data based on the second measurement data, the third measurement data, and the fourth measurement data.

19. The non-transitory machine-readable medium of claim 18, wherein the validating of the accuracy of the third measurement data is based on the controlled the first phase shift and a measured first phase shift, and wherein the validating of the accuracy of the fourth measurement data is based on the controlled second phase shift and a measured second phase shift.

20. The non-transitory machine-readable medium of claim 18, wherein the obtaining of the first measurement data comprises obtaining the first measurement data in a first Z-basis measurement, and obtaining the second measurement data in a second Z-basis measurement, wherein the applying of the controlled first rotation to the third qubit comprises applying an X-axis rotation to the third qubit, wherein the applying of the controlled second rotation to the fourth qubit comprises applying a Y-axis rotation to the third qubit, wherein the obtaining of the third measurement data comprises obtaining the third measurement data in an X-basis measurement, and wherein the obtaining of the fourth measurement data comprises obtaining the fourth measurement data in a Y-basis measurement.
